(19) United States
(12) Patent Application Publication
(10) Pub. No.: US 2019/0356696 A1
(43) Pub. Date: Nov. 21, 2019

(54) SYSTEM AND METHOD FOR CYBERSECURITY FRAMEWORK AMONG NETWORK DEVICES

(71) Applicant: SCHLUMBERGER TECHNOLOGY CORPORATION, Sugar Land, TX (US)

(72) Inventors: Juan Jose Rojas, Sugar Land, TX (US); Guillaume Jean Daniel TAMBOISE, Houston, TX (US)

(21) Appl. No.: 15/984,677

(22) Filed: May 21, 2018

(51) Int. Cl. H04L 29/06; H04L 9/32; G06F 21/57; H04L 12/24

(52) U.S. Cl. CPC H04L 63/20; H04L 63/105; H04L 63/083; G06F 21/44; G06F 21/57; H04L 41/0893; H04L 9/32

(57) ABSTRACT

A system may include a first set of network elements defining a first security zone within a drilling management network. The drilling management network may include a programmable logic controller (PLC) that performs a drilling operation using the first set of network elements. The system may include a second set of network elements defining a second security zone. The system may include a conduit coupled to the first security zone and the second security zone. The conduit may establish and terminate a virtual connection between the first set of network elements in the first security zone and the second set of network elements in the second security zone.

### BACKGROUND

Various network devices may be disposed throughout a drilling rig in order to control various operations on the drilling rig. These network devices may control drilling equipment, monitor the performance of the drilling rig, and/or perform various maintenance operations with respect to the drilling rig.

Traditionally, network devices on a drilling rig were rarely connected to the Internet or to other subsystems in an uncontrolled manner. However, as drilling rig networks have experienced increased system integration and greater remote functionality, the complexity of the technology has created evolving cybersecurity concerns. Automating a drilling rig network introduces dangers where malicious third parties may acquire access to drilling operations and equipment that was previously isolated from the Internet. Accordingly, various problems exist in regard to effective enforcement of security protocols with respect to such network devices on a drilling rig.

### SUMMARY

In general, in one aspect, the disclosed technology relates to a method. The method includes obtaining, from a network device, a request to access data from a control system located in a first security zone in a drilling management network. The network device is disposed in a second security zone. The method further includes authenticating, in response to obtaining the request, that the network device has access to the first security zone. The method further includes establishing, using a conduit and in response to authenticating the network device, a virtual connection between the first security zone and the second security zone. The conduit enforces a communication path between the first security zone and the second security zone. The method further includes transmitting, over the virtual connection, the data from the control system to the network device.

In general, in one aspect, the disclosed technology relates to a system. The system includes a first set of network elements defining a first security zone within a drilling management network. The drilling management network includes a programmable logic controller (PLC) that performs a drilling operation using the first set of network elements. The system further includes a second set of network elements defining a second security zone. The system further includes a conduit coupled to the first security zone and the second security zone. The conduit establishes and terminates a virtual connection between the first set of network elements in the first security zone and the second set of network elements in the second security zone.

In general, in one aspect, the disclosed technology relates to a non-transitory computer readable medium (CRM) storing instructions. The instructions include functionality for obtaining, from a network device, a request to access data from a control system located in a first security zone in a drilling management network. The network device is disposed in a second security zone. The instructions further include functionality for authenticating, in response to obtaining the request, that the network device has access to the first security zone. The instructions further include functionality for establishing, using a conduit and in response to authenticating the network device, a virtual connection between the first security zone and the second security zone. The conduit enforces a communication path between the first security zone and the second security zone. The instructions further include functionality for transmitting, over the virtual connection, the data from the control system to the network device.

Other aspects of the disclosure will be apparent from the following description and the appended claims.

### BRIEF DESCRIPTION OF DRAWINGS

FIGS. 1 and 2 show systems in accordance with one or more embodiments.

FIG. 3 shows an example in accordance with one or more embodiments.

FIG. 4 shows a flowchart in accordance with one or more embodiments.

FIGS. 5.1 and 5.2 show a computing system in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include a system and various methods for accessing assets in one or more security zones. In particular, one or more embodiments are directed to a system that includes one or more conduits coupling two or more security zones. For example, a conduit may provide a communication path between network devices located in different security zones. In some embodiments, a conduit is a temporary conduit that is controlled by a jump host or a virtual connection controller. With a temporary conduit, temporary virtual connections may be established and terminated in order to regulate authorized access to various control systems in a security zone. For example, a temporary conduit may limit network device access to specific times and/or to specifically authorized network devices.

Likewise, control systems in a drilling management network may publish data over one or more unidirectional conduits. For example, a network device may subscribe to data from a respective control system that is provided by a particular unidirectional conduit. When the respective control system broadcasts the data, any subscribers to the data may receive the data over the unidirectional conduit accordingly. However, the unidirectional conduit may prevent subscribers from transmitting commands back across the communication path. Thus, subscribers are limited to a passive role with respect to obtaining data from the unidirectional conduit.

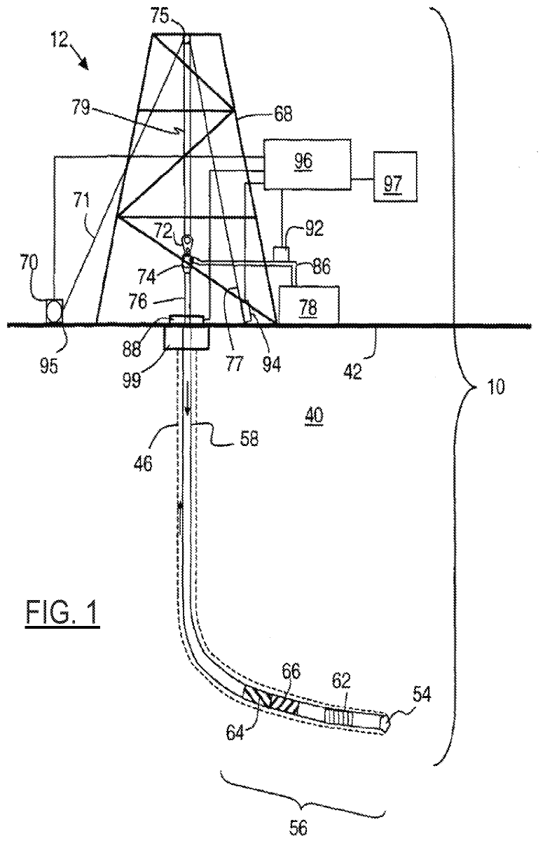

FIG. 1 shows a block diagram of a system in accordance with one or more embodiments. FIG. 1 shows a drilling system (10) according to one or more embodiments. Drill string (58) is shown within borehole (46). Borehole (46) may be located in the earth (40) having a surface (42). Borehole (46) is shown being cut by the action of drill bit (54). Drill bit (54) may be disposed at the far end of the bottom hole assembly (56) that is attached to and forms the lower portion of drill string (58). Bottom hole assembly (56) may include a number of devices including various subassemblies. Measurement-while-drilling (MWD) subassemblies may be included in subassemblies (62). Examples of MWD measurements may include direction, inclination, survey data, downhole pressure (inside the drill pipe, and/or outside and/or annular pressure), resistivity, density, and porosity. Subassemblies (62) may also include a subassembly for measuring torque and weight on the drill bit (54). The signals from the subassemblies (62) may be processed in a processor (66). After processing, the information from processor (66) may be communicated to pulser assembly (64). Pulser assembly (64) may convert the information from the processor (66) into pressure pulses in the drilling fluid. The pressure pulses may be generated in a particular pattern which represents the data from the subassemblies (62). The pressure pulses may travel upwards though the drilling fluid in the central opening in the drill string and towards the surface system. The subassemblies in the bottom hole assembly (56) may further include a turbine or motor for providing power for rotating and steering drill bit (54).

The drilling rig (12) may include a derrick (68) and hoisting system, a rotating system, and/or a mud circulation system, for example. The hoisting system may suspend the drill string (58) and may include draw works (70), fast line (71), crown block (75), drilling line (79), traveling block and hook (72), swivel (74), and/or deadline (77). The rotating system may include a kelly (76), a rotary table (88), and/or engines (not shown). The rotating system may impart a rotational force on the drill string (58). Likewise, the embodiments shown in FIG. 1 may be applicable to top drive drilling arrangements as well. Although the drilling system (10) is shown being on land, those of skill in the art will recognize that the described embodiments are equally applicable to marine environments as well.

The mud circulation system may pump drilling fluid down an opening in the drill string (58). The drilling fluid may be called mud, which may be a mixture of water and/or diesel fuel, special clays, and/or other chemicals. The mud may be stored in mud pit (78). The mud may be drawn into mud pumps (not shown), which may pump the mud though stand pipe (86) and into the kelly (76) through swivel (74), which may include a rotating seal. Likewise, the described technologies may also be applicable to underbalanced drilling. If underbalanced drilling is used, at some point prior to entering the drill string (58), gas may be introduced into the mud using an injection system (not shown).

The mud may pass through drill string (58) and through drill bit (54). As the teeth of the drill bit (54) grind and gouge the earth formation into cuttings, the mud may be ejected out of openings or nozzles in the drill bit (54). These jets of mud may lift the cuttings off the bottom of the hole and away from the drill bit (54), and up towards the surface in the annular space between drill string (58) and the wall of borehole (46).

At the surface, the mud and cuttings may leave the well through a side outlet in blowout preventer (99) and through mud return line (not shown). Blowout preventer (99) comprises a pressure control device and a rotary seal. The mud return line may feed the mud into one or more separators (not shown) which may separate the mud from the cuttings. From the separator, the mud may be returned to mud pit (78) for storage and re-use.

Various sensors may be placed on the drilling rig (12) to take measurements of the drilling equipment. In particular, a hookload may be measured by hookload sensor (94) mounted on deadline (77), block position and the related block velocity may be measured by a block sensor (95) which may be part of the draw works (70). Surface torque may be measured by a sensor on the rotary table (88). Standpipe pressure may be measured by pressure sensor (92), located on standpipe (86). Signals from these measurements may be communicated to a surface processor (96) or other network elements (not shown) disposed around the drilling rig (12). In addition, mud pulses traveling up the drillstring (58) may be detected by pressure sensor (92). For example, pressure sensor (92) may include a transducer that converts the mud pressure into electronic signals. The pressure sensor (92) may be connected to surface processor (96) that converts the signal from the pressure signal into digital form, stores and demodulates the digital signal into usable MWD data. According to various embodiments described above, surface processor (96) may be programmed to automatically detect one or more rig states based on the various input channels described. Processor (96) may be programmed, for example, to carry out an automated event detection as described above. Processor (96) may transmit a particular rig state and/or event detection information to user interface system (97) which may be designed to warn various drilling personnel of events occurring on the rig and/or suggest activity to the drilling personnel to avoid specific events.

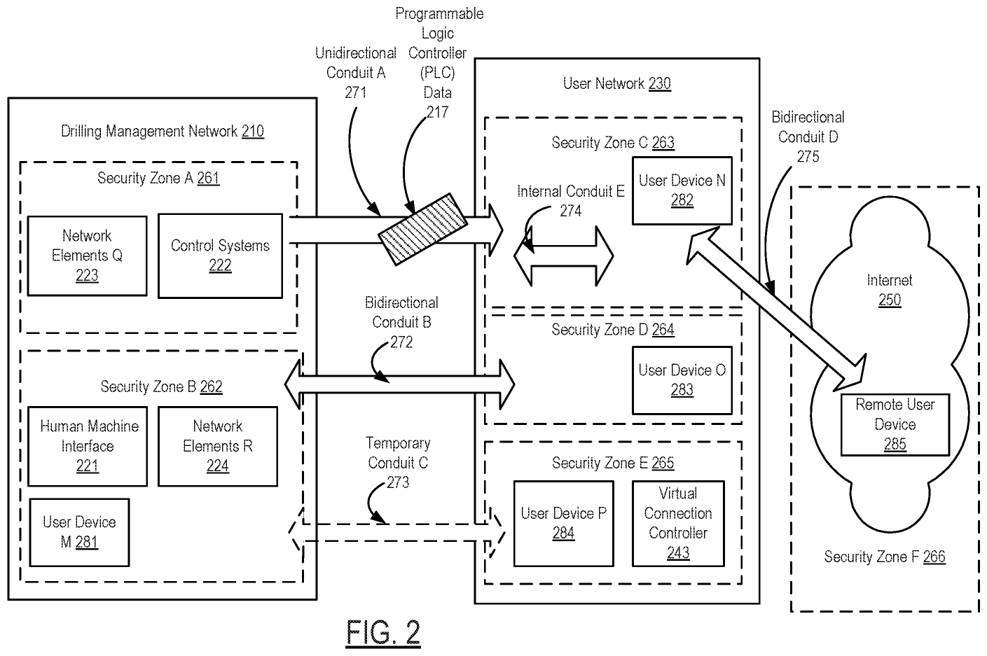

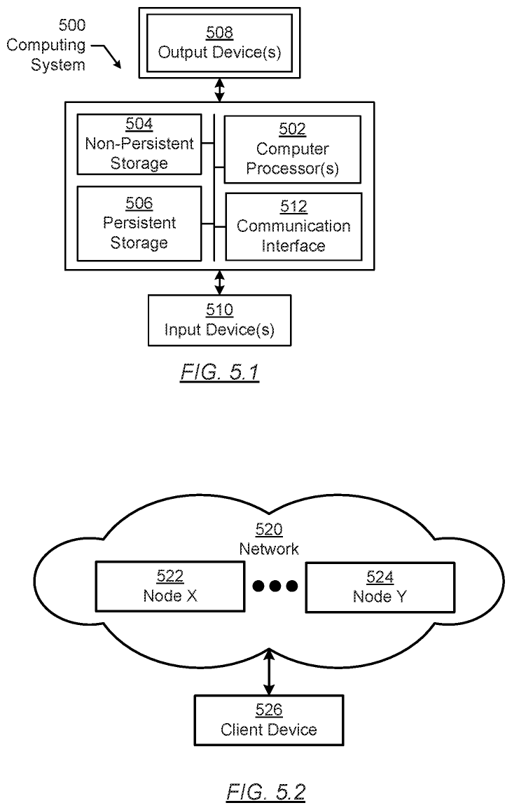

FIG. 2 shows a block diagram of a system in accordance with one or more embodiments. As shown in FIG. 2, a drilling management network (210) may include a human machine interface (HMI) (e.g., HMI (221)), a historian, various network elements (e.g., network elements Q (223), network elements R (224)) and/or various user devices (e.g., user device M (281)). A human machine interface may be hardware and/or software coupled to the drilling management network (210), and which includes functionality for presenting data and/or receiving inputs from a user regarding various drilling operations and/or maintenance operations performed within the drilling management network (210). For example, a human machine interface may include software to provide a graphical user interface (GUI) for presenting data and/or receiving control commands for operating a drilling rig. A network element may refer to various hardware components within a network, such as switches, routers, hubs, user equipment, or any other logical entities for uniting one or more physical devices on the network. User devices may include personal computers, smartphones, human machine interfaces, and any other devices coupled to a network that obtain inputs from one or more users. In some embodiments, the drilling management network (210) is coupled to a user network (e.g., user network (230)). In particular, the user network (230) may include various network elements (not shown), user devices (e.g., user device N (282), user device O (283), user device P (284)), and/or onsite user equipment. For example, onsite user equipment may include phone systems, personal computers, printers, application servers, and/or file servers located around a drilling rig. Network elements, the human machine interface (221), onsite user equipment, user devices, and/or the historian may be computing systems similar to the computing system (500) described in FIGS. 5.1 and 5.2, and the accompanying description.

In one or more embodiments, the drilling management network (210) includes drilling equipment (e.g., the blowout preventer (99), the drilling rig (12), and other components described above in FIG. 1 and the accompanying description). The drilling management network (210) may further include control systems (e.g., control systems (222)) such as various drilling operation control systems and various maintenance control systems that are deterministic network portions. Drilling operation control systems and/or maintenance control systems may include, for example, programmable logic controllers (PLCs) that include hardware and/or software with functionality to control one or more processes performed by a drilling rig, including, but not limited to the components described in FIG. 1. Specifically, a programmable logic controller may control valve states, fluid levels, pipe pressures, warning alarms, and/or pressure releases throughout a drilling rig.

Moreover, a programmable logic controller may be a ruggedized computer system with functionality to withstand vibrations, extreme temperatures, wet conditions, and/or dusty conditions, for example, around a drilling rig. Drilling operation control systems and/or maintenance control systems may also refer to control systems that include multiple PLCs within the drilling management network (210). Furthermore a control system may be a closed loop portion of a drilling management network that includes functionality to control operations within a system, assembly, and/or subassembly described above in FIG. 1 and the accompanying description. A PLC may transmit PLC data (e.g., PLC data (217)) to one or more devices coupled to the drilling management network (210) and/or the user network (230). PLC data may include sensor measurements, status updates, and/or information relating to drilling operations and/or maintenance operations performed on the drilling management network (210) that originates on the drilling management network (210). Likewise, one or more of the control systems (222) may include functionality to monitor and/or perform various drilling processes with respect to the mud circulation system, the rotating system, a pipe handling system, and/or various other drilling activities described with respect to FIG. 1 and the accompanying description

In one or more embodiments, the drilling management network (210) and/or the user network (230) are divided into various security zones (e.g., security zone A (261), security zone B (262), security zone C (263), security zone D (264), and security zone E (265)). In particular, a security zone may include hardware and/or software that includes functionality to enforce one or more access control policies for noncommunication assets within a portion of a network. For example, an access control policy may designate which users and/or types of users may have access to a noncommunication asset, and/or the ability to perform one or more functions associated with the noncommunication asset. In some embodiments, an access control policy is directed to one or more time windows when predetermined users have access to a respective noncommunication asset. In some embodiments, an access control policy includes various rules allowing network device access to one or more approved software applications, specify which network ports may receive data over a conduit, and/or designate network protocols for using approved Internet Protocol (IP) Addresses across the conduit.

Noncommunication assets may correspond to human machine interfaces, drilling equipment, user equipment, servers, personal computers, various network elements, and/or various network devices. Likewise, a security zone may implement an access control policy using various communication assets. For example, communication assets may include hardware and/or software that includes functionality for transmitting data over a communication path, such as routers, switches, personal computers, and/or other network elements. Enforcement of various access control policies may include network enforcement using various network communication protocols and nonnetwork enforcement, such as physically locking cabinets that host PLCs, servers, switches, firewalls and other equipment.

In some embodiments, security zones are further defined into subzones. For example, each subzone in a security zone may have respective access control policies specific to the subzone and general access control policies that apply to each subzone within the security zone. Subzones may be on separate broadcast domains within a particular security zone.

In one or more embodiments, one or more conduits (e.g., unidirectional conduit A (271), bidirectional conduit B (272), temporary conduit (273), bidirectional conduit D (275)) couple various security zones. Specifically, a conduit may include communication assets that implement one or more network communication protocols operating between different security zones. For example, a bidirectional conduit (e.g., bidirectional conduit B (272)) may implement an access control policy that provides similar rules for transmitting and receiving data by network devices located on either security zone coupled by the bidirectional conduit. For example, user device M (281) may transmit and request the same data over the bidirectional conduit B (272) as user device O (283) that is disposed in a different security zone.

In some embodiments, a drilling management network (210) and/or a user network (230) includes a unidirectional conduit (e.g., unidirectional conduit A (271)). A unidirectional conduit may implement an access control protocol that limits certain types of data transfers to a single direction within a network. For example, a unidirectional conduit may provide for transmission of specific types of sensor data to a predetermined security zone, while preventing certain types of data, e.g., setting adjustments, control commands, etc. from being received from the same security zone. As shown in FIG. 2, user device N (282) may read PLC data (217) from the control systems (222), but may not transmit control commands affecting the type of PLC data sent by the control systems (222).

In some embodiments, a drilling management network (210) and/or a user network (230) includes one or more temporary conduits (e.g., temporary conduit C (275)) coupling two or more security zones. In one or more embodiments, a temporary conduit is a switched virtual connection. For example, a switched virtual connection may include hardware and/or software on a security zone in the drilling management network (210) and another security zone in the user network (230) for implementing a virtual connection. Thus, when the switched virtual connection is “open”, no virtual connection may exist across the temporary conduit. When the switched virtual connection is “closed”, a virtual connection is formed that corresponds to a temporary virtual circuit. The temporary virtual circuit may then provide transmission of network traffic, such as PLC data, between two security zones. In particular, the default state of the switched virtual connection may be where two security zones are disconnected until an authorized user and/or user device requests access. In some embodiments, a virtual connection across a temporary conduit is terminated during drilling operations performed by one or more control systems, while a virtual connection may be established when no drilling operations are present in the drilling management network.

In some embodiments, for example, a temporary conduit is operated by a virtual connection controller (e.g., virtual connection controller (243)). A virtual connection controller may include hardware and/or software that includes functionality to establish a virtual connection across a temporary conduit. The virtual connection may be, for example, a data link layer connection between two adjacent communication assets, e.g., such as a physical link that includes switches located in different security zones. In other embodiments, the virtual connection may be a point-to-point connection over multiple network nodes. Moreover, the virtual connection controller (243) may be a virtual machine (VM) or a physical network element located in the drilling management network (210) and/or the user network (230). For example, a virtual connection controller (243) may be a jump host or a network element that communicates with a jump host. In one or more embodiments, for example, the virtual connection controller (243) includes functionality to power on and/or power off a jump host that provides communication with network devices in a particular security zone.

In some embodiments, a security zone includes one or more internal conduits (e.g., internal conduit E (274)). For example, an internal conduit may enforce one or more access control policies between two or more noncommunication assets within a single security zone, e.g., communication governed by a specific access control policy between two software applications operating within the single security zone or a single subzone. For example, an internal conduit may enforce an access control policy between a control system operated by a drilling management network and a network device provided by a third party vendor that is outside the control of the drilling management network.

In another embodiment, two control systems located in the same security zone or subzone communicate over an internal conduit. For example, control systems within a security zone may be located on the same broadcast domain. Thus, it may not be feasible to implement a firewall or other communication infrastructure that enforces an access control policy between the two control systems. As such, the internal conduit may implement IP address filtering, port filtering, and/or another type of network filtering for enforcing secure communication between the two control systems. Likewise, when functional network limitations prevent the separation of network devices onto different zones or subzones, such as when network devices are managed by different groups or third parties, communication may still be secured.

In some embodiments, a conduit couples a security zone to a different security zone that is located outside the drilling management network (210) and the user network (230). For example, as shown in FIG. 2, a security zone F (266) corresponds to the Internet (250). In particular, a remote user device (285) may communicate over bidirectional conduit D (275) with user device N (282) that is disposed in security zone C (263) located in the user network (230).

While FIGS. 1 and 2 show various configurations of components, other configurations may be used without departing from the scope of the disclosure. For example, various components in FIGS. 1 and 2 may be combined to create a single component. As another example, the functionality performed by a single component may be performed by two or more components.

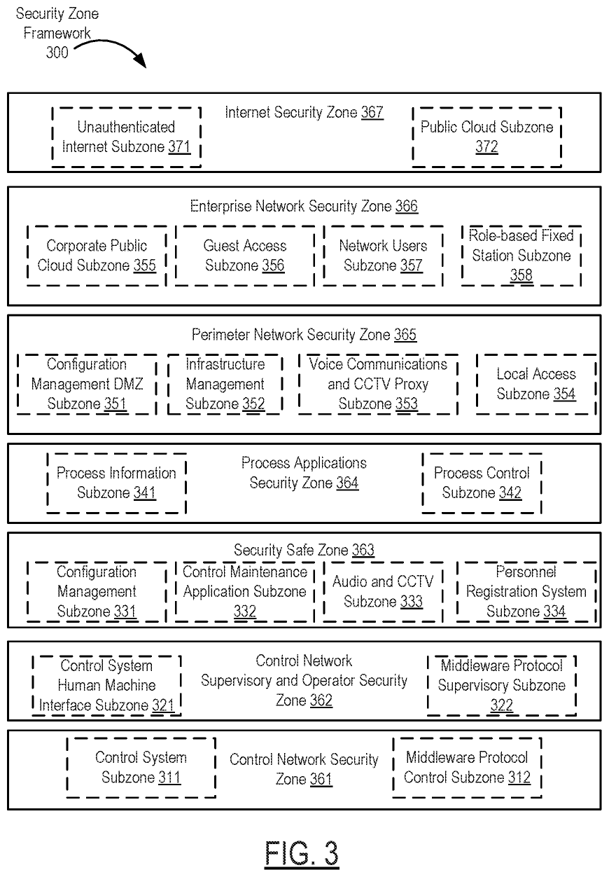

Turning to FIG. 3, FIG. 3 provides an example of a security zone framework (300) for one or more networks. The following example is for explanatory purposes only and not intended to limit the scope of the disclosure. Turning to FIG. 3, the security zone framework (300) includes a control network security zone (361) that includes a control system subzone (311) and a middleware protocol control subzone (312). Systems in the control network security zone (361) and corresponding sub-zones may abide by various access control policies that include storage and computation power being dedicated and cannot be shared with any other security zone. In the control system subzone (311), control systems here may have fast control loops (e.g., up to 1 kHz) that may be maintained in a deterministic computing environment. The control system subzone (311) may have the highest level of security within the security zone framework (300). For example, control loops deadlines in the control system subzone (311) may affect data availability, whereby data availability may be compromised by increasing network latency or jitter. A conduit between the control system subzone (311) and the middleware protocol control subzone (312) may be implemented by a soft PLC (IPC) or a bare metal gateway that translates fieldbus protocols such as EtherNet/IP, Profinet, Profibus, Modbus TCP/IP or EtherCat into a middleware protocol. Soft PLC logic may map fieldbus memory addresses into middleware protocol topics and back accordingly, such as by following a whitelist approach. In the middleware protocol control subzone (312), one or more middleware protocols may be used to coordinate various control systems. For example, various assets in the middleware protocol control subzone (312) may interface between equipment control and well construction process control. Here, control loops may be closed loops that operate at high data frequencies (e.g., up to 1 kHz), and may run asynchronously in softer real time.

Moreover, the security zone framework (300) further includes a control network supervisory and operator (CNSO) security zone (362) that includes a control system human machine interface (CSHMI) subzone (321) and a middleware protocol supervisory subzone (322). The CNSO security zone (362) may include interfaces for supervisory control, e.g., by human operators or by algorithms that are granted similar access as human operators. As such, the CSHMI subzone (321) includes a control system interface for human operators, e.g., joystick, touchpad, and/or touchscreens. Specifically, a drilling chair may reside in the CSHMI subzone (321). A conduit coupling the CSHMI subzone (321) and the middleware protocol control subzone (312) may allow human operators to interact with middleware protocol-based representations of the equipment (e.g., description, capabilities, calibration, etc.). The conduit may accordingly grant various control capabilities to various network devices. Likewise, middleware protocol users may be authenticated using various security certificates. Here, subscribe capability and/or data access may be segmented through middleware protocol domains. For example, a bidirectional conduit may couple the middleware protocol supervisory subzone (322) and the middleware control protocol subzone (312). This bidirectional conduit may grant coordinated control algorithms a differentiated access to sensor data and to control capability for one or more control systems.

Keeping with the CNSOS security zone (362), the middleware protocol supervisory subzone (322) may host various middleware protocol-based advanced coordinated control algorithms that are executed in soft real-time. With respect to the access control policies in the middleware supervisory subzone (322), various computing environments may be segregated via a virtualization hypervisor and/or physical separations. Control capability and/or data access may also be segmented through middleware protocol domains.

Keeping with FIG. 3, the security zone framework (300) further includes a security safe zone (363) that includes a configuration management subzone (331), a control maintenance application subzone (332), a voice and closed-circuit television (CCTV) subzone (333), and a personnel registration system subzone (334). In particular, the security safe zone (363) may host support infrastructure that complements assets in the control network security zone (361) and the CNSOS security zone (362). For example, access control policies in the security safe zone (363) may include aggressive operating system patching for MAC address devices that whitelist at physical network connection points. Conduits within the security safe zone (363) and that exit this zone may be authenticated using security certificates (e.g., middleware protocol, HTTPS) along with managed firewall deep packet inspection.

Keeping with the security safe zone (363), the personnel registration system subzone (334) may be where local roles for various security zones and subzones are defined and maintained. The control maintenance application subzone (332) may include systems tasked with managing updates and upgrades on control systems in the control network security zone (361). For example, a temporary conduit may couple the control maintenance application subzone (332) and control system subzone (311). Upon approval (e.g., a designated time window), the temporary conduit may be enabled to allow transfer of software, firmware and/or configuration upgrades from the control maintenance application subzone (332) to control systems in the control system subzone (311). Likewise, the temporary conduit may include multi-factor authentication for access.

Furthermore, the security zone framework (300) further includes a process applications security zone (364) that includes a process information subzone (341) and a process control subzone (342). The process applications security zone (364) may include network devices responsible for process control decisions with participation of users and out-of-rig components. In some embodiments, a unidirectional conduit may allow applications and workflows in the process information subzone (341) to consume data from the middleware protocol subzone (312). In the process information subzone (341), network devices may only subscribe to the information pushed by middleware protocol subzone (312). For example, a sensor device or a control system may publish data that is transmitted over the unidirectional conduit and received by one or more subscribers in the process information subzone (341). In particular, one or more network communication protocols associated with the unidirectional conduit may implement a software architecture that enables a publish-subscribe model among various network devices on and/or connected to the middleware protocol subzone (312). If a respective network device or a component of the respective network device is a subscriber for a particular sensor device or control system, data from the sensor device or control system may be relayed over the unidirectional conduit. If a sensor device has five subscribers, for example, sensor data from the sensor device may be transmitted to each of the five subscribers each time that sensor data is broadcast over the unidirectional conduit. Thus, the sensor device may act as a publisher in a publish-subscribe model. In some embodiments, a drilling management network uses a security certificate to authenticate a device before it is allowed to publish or subscribe on the unidirectional conduit.

In the process control subzone (342), network devices may implement orchestration services that are granted various control capabilities. This zone may be delimited via control capability granted via middleware protocol domain.

The security zone framework (300) further includes a perimeter network security zone (365) that includes a configuration management demilitarized (DMZ) subzone (351), an infrastructure management subzone (352), a voice communications and CCTV proxy subzone (353), and a local access subzone (354). A perimeter network security zone (365) may correspond to noncommunication assets located in a perimeter network. For example, a perimeter network may be a logical or physical subnetwork of a drilling management network and/or user network that exposes an organization's external facing serves to an untrusted network, e.g., the Internet and/or an enterprise network. The perimeter network security zone (365) may be a relatively low security level in the security zone framework (300) and may couple to conduits that interface with the control systems in a drilling management network and with out-of-rig systems.

Staying with FIG. 3, the security zone framework (300) further includes an enterprise network security zone (366) that includes a corporate public cloud subzone (355), a guest access subzone (356), a network users subzone (357), and a role-based fixed station subzone (358). The enterprise network security zone (366) may correspond to an enterprise network that may connect user devices and network devices across various departments and work group networks. For example, an enterprise network may be an organization's backbone that provides communication and network resources to employees and guests in many different departments. Beyond the enterprise network security zone (366) is the Internet security zone (367) that includes an unauthenticated Internet subzone (371) and a public cloud subzone (372).

While various conduits are discussed with respect to the security zones and subzones of the security zone framework (300) of FIG. 3, a person of ordinary skill in the art would know in light of the disclosed technology that one or more unidirectional conduits, one or more bidirectional conduits, and/or one or more temporary conduits may couple any two security zones or subzones of the security zone framework (300). Likewise, one or more internal conduits may be disposed within any security zone and/or security subzone of the security zone framework (300).

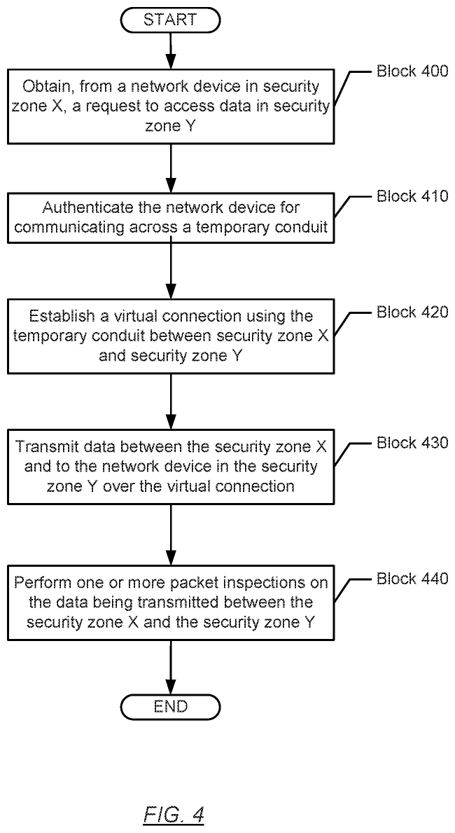

Turning to FIG. 4, FIG. 4 shows a flowchart in accordance with one or more embodiments. Specifically, FIG. 4 describes a method for accessing assets in one or more security zones located in a drilling management network and/or a user network. One or more blocks in FIG. 4 may be performed by one or more components (e.g., virtual connection controller (243)) as described in FIGS. 1, 2, and/or 3. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 400, a request to access data in security zone Y is obtained from a network device in security zone X in accordance with one or more embodiments. For example, a network device may be a user device that transmits a request to a virtual connection controller managing the conduit between the zones. The user device may be connected locally on a user network and/or a drilling management network and/or remotely connected to the virtual connection controller, e.g., over the Internet. Likewise, the user device may be a control system or one or more network elements located in a user network or a drilling management network. For example, a control system may request data from one or more other control systems to perform an algorithm associated with a specific drilling operation. Security zone X and/or security zone Y may be similar to the security zones described above in FIGS. 2 and 3 and the accompanying description.

In Block 410, a network device is authenticated for communicating across a temporary conduit in accordance with one or more embodiments. For example, the temporary conduit may couple security zone X and security zone Y. In response to obtaining the request in Block 400, for example, a network device and/or software application may determine whether the network device has permission to access data from one or more noncommunication assets located in a specific security zone. For example, a virtual connection controller may access a user account associated with a user device and/or a user operating the user device. The user account may include user credentials that designate which PLCs a user and/or user device may access. To complete the authentication the network device may require additional user credentials which may be manually entered into the user account by an administrator and/or automatically generated based on various information associated with a user and/or user device stored in the user account or elsewhere.

Furthermore, the user credentials may also specify one or more time windows when a user and/or user device may communicate across the temporary conduit. Likewise, user credentials may time window attributes, such as data fields that provide information regarding starting times, ending times, particular days of the week, month, or year, and allotted amounts of time for various time windows assigned to a user and/or network device. Moreover, time window attributes may describe general time windows and specific time windows.

In one or more embodiments, a virtual connection controller implements a multi-factor authentication for a temporary conduit between two security zones. For example, a user device may log into a user network with a username and password. Accordingly, after establishing a network connection to the user network, the virtual connection controller may request an additional password and/or identification to establish a virtual connection across a temporary conduit. For example, the additional password and/or identification information may be a personal identification number, a biometric identifier such as a fingerprint, personal information regarding the user requesting access, and/or a network device code transmitted independently to a user device.

In some embodiments, for example, a time bounded set of virtual connection credentials are generated for a temporary conduit. For example, the virtual connection credentials may include network and/or firewall configurations for communicating across a virtual connection. Moreover, in response to a virtual connection controller determining that a user device is authorized, the virtual connection credentials may include a network device code specifically generated by a virtual connection controller or other network element for the network device. A network device code may be a pseudorandom or otherwise predetermined alphanumeric sequence that enables a network device to communicate with a PLC and/or control system on the drilling management network.

In Block 420, a virtual connection is established using a temporary conduit between a security zone X and a security zone Y in accordance with one or more embodiments. If a determination is made that the user device is authorized to access noncommunication assets in a security zone, for example, a virtual connection controller may establish the virtual connection across the temporary conduit. If a switched virtual connection exists between the two security zones, the virtual connection controller may enable network communication across the switched virtual connection to establish the virtual connection. On the other hand, if the determination is made by a virtual connection controller that a network device is not authorized to access one or more specific noncommunication assets in the security zone and/or the user device is not authorized at the current time, the virtual connection may not be established in Block 420.

In one or more embodiments, a virtual connection controller is shut down and/or physically disconnected from a drilling management network and/or a user network. After a network device is authenticated in Block 410, the virtual connection controller may power up and establish the virtual connection over the temporary conduit. In some embodiments, a virtual connection controller or other software application may terminate the virtual connection established in Block 420. For example, a virtual connection controller may remove a data link layer connection that returns the temporary conduit into a closed state. Likewise, firewall settings may be set by a virtual connection controller to block network traffic over the temporary conduit. In the case of a switched virtual connection, the virtual connection controller may set the switched virtual connection to be an open circuit. In one or more embodiments, for example, the virtual connection controller shuts down and disconnects after a determination is made to terminate the virtual connection.

In Block 430, data is transmitted between a security zone X and to a network device in a security zone Y over a virtual connection in accordance with one or more embodiments. For example, a network device may obtain PLC data from a control system located in security zone X. Likewise, the network device may transmit one or more control commands for adjusting parameters and/or settings in one or more control systems in security zone X. In other words, once a virtual connection is established, a network device may have read and/or control access with respect to one or more noncommunication assets in a particular security zone. For example, in one or more embodiments, access is directed towards control commands being sent into across a temporary conduit to monitor and control assets in the security zone.

In Block 440, one or more packet inspections are performed on data being transmitted between security zone X and security zone Y in accordance with one or more embodiments. In a packet inspection, one or more portions of transmitted data across a conduit may be analyzed to determined whether one or more access control policies are being violated. For example, a packet inspection may be performed by a firewall and/or one or more network elements in a drilling management network and/or a user network. In some embodiments, for example, a deep packet inspection is performed on data being transmitted over the temporary conduit in Block 420 or other conduits operating within a drilling management network or user network.

While a temporary conduit is referenced above in FIG. 4 and the accompanying description, in other embodiments, similar blocks may be applied to unidirectional conduits and/or bidirectional conduits. Likewise, the embodiments described in reference to FIG. 4 may also be applied to internal conduits operating within a single security zone. Moreover, subzones may be used in place of security zones in the technologies described above in FIG. 4.

Embodiments may be implemented on a computing system. Any combination of mobile, desktop, server, router, switch, embedded device, or other types of hardware may be used. For example, as shown in FIG. 5.1, the computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), and numerous other elements and functionalities.

The computer processor(s) (502) may be an integrated circuit for processing instructions. For example, the computer processor(s) may be one or more cores or micro-cores of a processor. The computing system (500) may also include one or more input devices (510), such as a touchscreen, keyboard, mouse, microphone, touchpad, electronic pen, or any other type of input device.

The communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (500) in FIG. 5.1 may be connected to or be a part of a network. For example, as shown in FIG. 5.2, the network (520) may include multiple nodes (e.g., node X (522), node Y (524)). Each node may correspond to a computing system, such as the computing system shown in FIG. 5.1, or a group of nodes combined may correspond to the computing system shown in FIG. 5.1. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (500) may be located at a remote location and connected to the other elements over a network.

Although not shown in FIG. 5.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (522), node Y (524)) in the network (520) may be configured to provide services for a client device (526). For example, the nodes may be part of a cloud computing system. The nodes may include functionality to receive requests from the client device (526) and transmit responses to the client device (526). The client device (526) may be a computing system, such as the computing system shown in FIG. 5.1. Further, the client device (526) may include and/or perform all or a portion of one or more embodiments of the disclosure.

The computing system or group of computing systems described in FIGS. 5.1 and 5.2 may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system (500) in FIG. 5.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 5.1, while performing one or more embodiments of the disclosure, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B includes comparing the first element of vector A with the first element of vector B, the second element of vector A with the second element of vector B, etc. In one or more embodiments, if A and B are strings, the binary values of the strings may be compared.

The computing system in FIG. 5.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 5.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 5.1 and the nodes and/or client device in FIG. 5.2. Other functions may be performed using one or more embodiments of the disclosure.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A system, comprising:
a first plurality of network elements defining a first security zone within a drilling management network, the drilling management network comprising one or more programmable logic controllers (PLCs) configured for performing one or more drilling operations using the first plurality of network elements;
a second plurality of network elements defining a second security zone; and
a first conduit coupled to the first security zone and the second security zone,
wherein the first conduit is configured to establish and terminate a virtual connection between the first plurality of network elements in the first security zone and the second plurality of network elements in the second security zone.

2. The system of claim 1,
wherein the first security zone is located in a user network,
wherein the second security zone is located in a closed loop portion of a drilling management network.

3. The system of claim 1, further comprising:
a second conduit coupled to the first security zone and a third security zone comprising a third plurality of network elements,
wherein the second conduit is a unidirectional conduit configured for transmitting PLC data from the one or more PLCs to at least one network element among the third plurality of network elements.

4. The system of claim 1, further comprising:
a second conduit coupled to the first security zone and a third security zone comprising a third plurality of network elements,
wherein the second conduit is a unidirectional conduit that is further configured to transmit the PLC data to subscribers using a middleware network protocol.

5. The system of claim 1, further comprising:
a second conduit disposed inside the first security zone,
wherein the second conduit is an internal conduit operating between two or more control systems disposed inside the first security zone.

6. The system of claim 1, further comprising:
a jump host coupled to the first conduit, wherein the jump host is configured to establish or terminate the virtual connection.

7. The system of claim 1,
wherein the first conduit comprises a switched virtual connection, and
wherein the switched virtual connection is a physical link configured to become a data link layer connection between adjacent network nodes in the first plurality of network elements and the second plurality of network elements, and
wherein the switched virtual connection is configured to become the data link layer in response to determining that a network device is authorized for connecting to the first security zone.

8. The system of claim 1, further comprising:
a second conduit coupled to the second security zone and a third security zone comprising an enterprise network,
wherein the second security zone is a perimeter network, and
wherein the second conduit comprises a firewall that monitors and controls network traffic between the second security zone and the third security zone.

9. The system of claim 8, further comprising:
a third conduit coupled to the third security zone and a fourth security zone comprising a remote user device,
wherein the third conduit implements a network connection over the Internet between the remote user device and the third security zone, and
wherein the first conduit, second conduit, and third conduit are configured to provide a communication path from the remote user device to the one or more PLCs in the first security zone.

10. The system of claim 1,
wherein the first conduit comprises at least one network switch operating at least one network communication protocol.

11. The system of claim 1,
wherein the first plurality of network elements in the first security zone are noncommunication assets within the drilling management network.

12. A method, comprising:
obtaining, from a first network device, a request to access data from a first control system located in a first security zone in a drilling management network, and wherein the first network device is disposed in a second security zone;
authenticating, in response to obtaining the request, that the first network device has access to the first security zone;
establishing, using a conduit and in response to authenticating the first network device, a virtual connection between the first security zone and the second security zone, wherein the conduit enforces a communication path between the first security zone and the second security zone; and
transmitting, over the virtual connection, the data from the first control system to the first network device.

13. The method of claim 12,
wherein the first security zone is located in a closed loop portion of the drilling management network, and
wherein the second security zone is located in a user network.

14. The method of claim 12, further comprising:
transmitting, over a unidirectional conduit, programmable logic controller (PLC) data from a second control system in the first security zone and to a plurality of network elements in a third security zone,
wherein the plurality of network elements automatically perform one or more maintenance operations using the PLC data and one or more algorithms.

15. The method of claim 14, wherein the plurality of network elements are subscribers that use a middleware network protocol.

16. The method of claim 12,
wherein the authentication of the network device is performed by a jump host coupled to the conduit, and
wherein the jump host establishes the virtual connection over the conduit.

17. The method of claim 12, further comprising:
performing a packet inspection on data that is being transmitted over the conduit.

18. A non-transitory computer readable medium storing instructions, the instructions comprising functionality for:
obtaining, from a first network device, a request to access data from a first control system located in a first security zone in a drilling management network, and wherein the first network device is disposed in a second security zone;
authenticating, in response to obtaining the request, that the first network device has access to the first security zone;
establishing, using a conduit and in response to authenticating the first network device, a virtual connection between the first security zone and the second security zone, wherein the conduit enforces a communication path between the first security zone and the second security zone; and
transmitting, over the virtual connection, the data from the first control system to the first network device.

19. The non-transitory computer readable medium of claim 18,
wherein the first security zone is located in a closed loop portion of the drilling management network, and
wherein the second security zone is located in a user network.

20. The non-transitory computer readable medium of claim 18, wherein the instructions further comprise functionality for:
transmitting, over a unidirectional conduit, programmable logic controller (PLC) data from a second control system in the first security zone and to a plurality of network elements in a third security zone,
wherein the plurality of network elements automatically perform one or more maintenance operations using the PLC data and one or more algorithms.
